(19) United States
(12) Patent Application Publication
(10) Pub. No.: US 2016/0306555 A1
(43) Pub. Date: Oct. 20, 2016

(54) STORAGE CAPACITY REGRESSION

(71) Applicants: Sinchan BANERJEE, Karnataka (IN); Sourin SARKAR, Karnataka (IN); HEWLETT-PACKARD DEVELOPMENT COMPANY, L.P., Houston, TX (US)

(72) Inventors: Sinchan Banerjee, Bangalore (IN); Sourin Sarkar, Bangalore (IN)

(21) Appl. No.: 15/102,997

(22) PCT Filed: Dec. 20, 2013
(86) PCT No.: PCT/IN2013/000784

§ 371 Date: Jun. 9, 2016

(51) Int. Cl. G06F 3/06; G06F 17/18; G06F 11/14; G06N 5/04

(52) U.S. Cl. CPC G06F 3/0604; G06N 5/048; G06F 17/18; G06F 3/0619; G06F 3/0653; G06F 3/067; G06F 11/1458; G06F 3/065; G06F 3/0631; G06F 2201/84

(57) ABSTRACT

A set of storage capacity data points may be obtained. A regression may be determined from the set. A set of coefficients of determination for a subset of the set may be obtained. A breakpoint for a subsequent regression may be determined from a point of the subset having a maximal coefficient of determination.

### BACKGROUND

A backup system may be used to copy and archive computer data to allow the computer data to be restored in the event of a data loss event. Backup systems may require increasing amounts of data storage availability as additional computer data is created. To assist a system administrator plan for data storage needs, a backup system may include management tools that forecast backup storage availability. For example, a storage availability forecaster may be used by a system administrator to plan the purchase or allocation of additional backup data storage.

### BRIEF DESCRIPTION OF THE DRAWINGS

Certain examples are described in the following detailed description and in reference to the drawings, in which:

FIG. 1 illustrates an example of piecewise linear regression that might be performed by an example forecasting system;

FIG. 2 illustrates an example system that may provide a storage capacity forecast;

FIG. 3 illustrates an example forecasting system in a storage environment;

FIG. 4 illustrates an example method of setting a regression breakpoint;

FIG. 5 illustrates an example method of operation of a storage forecaster;

FIG. 6 illustrates an example method of determining a size of a set of storage capacity data points; and

FIG. 7 illustrates an example computer having a non-transitory computer readable medium storing instruction executable by a processor to perform a regression on a series of a storage capacity data points.

### DETAILED DESCRIPTION OF SPECIFIC EXAMPLES

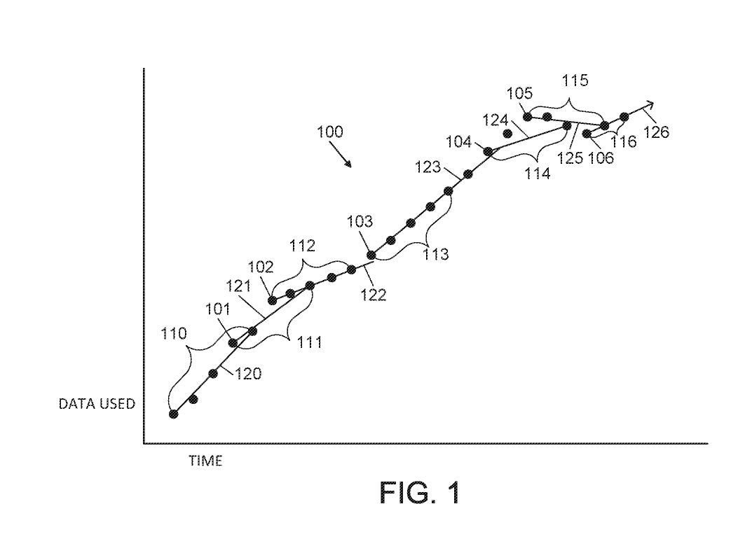

Some implementations of the disclosed technology may forecast data availability using piecewise regression performed on backup storage capacity data. For example, FIG. 1 illustrates an example of piecewise linear regression that might be performed by an example forecasting system. In some cases, a forecasting system may obtain a series 100 of storage usage data points. For example, a backup system may provide the series 100 through an application programming interface (API) or in response to a representational state transfer (REST) request by the forecasting system.

In some cases, a forecasting system may calculate regression lines 120-126 on data points within sets 110-116 of the data, respectively. The size of the sets 110-116 may be determined by evaluating characteristics of the data 100. For example, the data 100 may be evaluated to determine a size that is likely to encompass changes in the linearity of the data 100. In the illustrated example, the size is five data points.

In an example forecasting procedure, regression lines 120-126 may be determined using data within sets 110-116, respectively. In this example, a regression line 120-126 may be used to determine a breakpoint 101-106 or to determine a forecast. A breakpoint 101-106 may be a starting point for a subsequent set 111-116 and, therefore, a subsequent regression line 121-125. A forecast may be an interpolation of a regression line 126 into the future and may be used to predict an amount of storage that will be used at a future time, or to predict when an amount of storage will be exhausted.

In some cases, a breakpoint 101-106 may be a point that has a sufficient displacement from a corresponding regression line 120-125. For example, breakpoint 101 is a point within the set 110 that has a sufficient displacement from the regression line 120. Accordingly, breakpoint 101 may be used as the first point within the second set 111. Similarly breakpoint 102, which has a maximum displacement from regression line 121 may be used as the first point in the set 112, and, therefore, the first point in regression line 122. If no point in a set 110-115 has a sufficient displacement, then the corresponding regression line 120-125 may be extended and a point outside the corresponding set 110-115 may be used as a breakpoint. For example, none of the points in the set 112 have a sufficient displacement, so point 103 may serve as the breakpoint for set 113. As another example, point 104 may be determined to be the breakpoint for set 114 by extending the regression line 123 past set 113.

In some implementations, after proceeding in the above manner until all sets 110-115 having the set size have been creating, the remaining points 116 may be used to provide a storage capacity forecast. For example, a regression line 126 may be created using the last points 116. The regression line 126 may be extended into the future to determine a forecasted storage capacity at a future time.

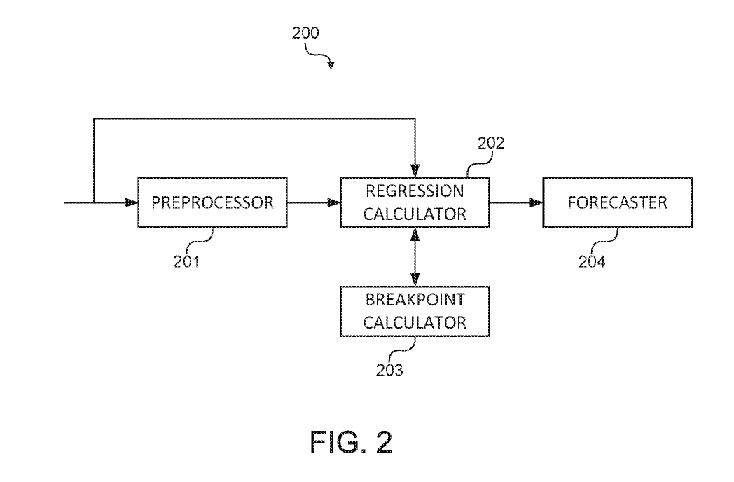

FIG. 2 illustrates an example system 200 that may provide a storage capacity forecast. In some cases, the example system 200 components 201-204 may be implemented in hardware, as instructions stored in non-transitory computer readable media and executed by a processor, or a combination thereof. The example system 200 may perform regression of sets of storage usage data to provide a storage capacity forecast. For example, the example system 200 may perform a first regression on a first set of data to determine a breakpoint for a second set of data. The example system 200 may perform a second regression on a second set of data to provide a storage capacity forecast.

The example system 200 may include a preprocessor 201. The preprocessor 201 may determine a set size from storage usage data. For example, the preprocessor 201 may use an API or REST interface to receive the storage usage data from a backup storage system. In some implementations, the preprocessor 201 may analyze the storage usage data to determine characteristics of the backup environment that may be used to determine the set size. In some implementations, the characteristics may be determined by analyzing factors such as the slope of storage usage data points, slope differences between points, and storage change ratios.

The example system 200 may also include a regression calculator 202. The regression calculator may determine a first regression for a first set of storage usage data. In some cases, the first set of storage usage data may have the set size. For example, the regression calculator 202 may obtain the set size from the preprocessor 201 and may retrieve a first set of storage usage data from the backup storage system. The regression calculator may determine the first regression on storage usage data points within the first set. In some implementations, the regression calculator may calculate a linear regression line on the storage usage data points. For example, the linear regression line may be calculated as:

$$y = {y}_{1} + \frac{( {y}_{N} - {y}_{1} )}{( {x}_{N} - {x}_{1} ) * ( x - {x}_{1} )} , \qquad ( 1 )$$

where (x₁, y₁) is the first data point of the first set, (x_{N}, y_{N}) is the last data point of the first set, and N is the set size. Accordingly, in this example, the linear regression is a line intersecting the first and last data point of the first set. In other cases, the linear regression line may be calculated in other manners. For example, the line may be calculated using a least squares approach or a least absolute deviation regression. In further implementations, the regression calculator may calculate a non-linear regression on the storage usage data points within the first set.

The example system 200 may also include a breakpoint calculator 203. The breakpoint calculator 203 may set a starting point for a second set at a point having a maximal displacement with respect to the regression. For example, the point may be an element of the first set having a maximal coefficient of determination with respect to the regression. In some implementations, breakpoint calculator may determine the coefficient of determination with respect to the regression for each point in the first set. If a point has a maximal coefficient determination, the breakpoint calculator 203 may set that point as the starting point for the second set. In some cases, the coefficient of determination (CoD) for a point having a data capacity value, y_{curr}, may be approximated as:

$${C}_{d} \approx 1 - \frac{{\sum }_{y = {y}_{1}}^{{y}_{curr}} {( y - {y}_{r} )}^{2}}{{\sum }_{y = {y}_{1}}^{{y}_{curr}} {( y - {y}_{∞} )}^{2}} , \qquad ( 2 )$$

where yᵣ is the value of y_{curr} predicted from the regression, y is the observed value, y_{∞} is the mean value of y within the first set, and y₁ is the first value of y in the set upon which the regression is performed. In some cases, the first point having a CoD of 1 is selected as the point having the maximal coefficient of determination. In other cases, subsets of the set are evaluated to determine a locally maximal CoD. For example, the point having the maximal coefficient of determination may be the first point having a CoD larger than its two preceding points and its two succeeding points.

In some cases there may be no point in the first set that has a maximal CoD. For example, there may be a threshold CoD that must be exceeded for a point to be a candidate starting point. As another example, all points in the first set may have a CoD of 0 or the CoDs may be monotonically increasing. In these cases, the regression line may be extended past the first set and coefficients of determination for subsequent points may be determined. For example, the points in increasing temporal sequence after the first set may be evaluated until one of the points has a CoD greater than its two preceding points and its two succeeding points. This locally maximal point outside the first set may be set as the starting point for the second set.

In some implementations, the breakpoint calculator 203 may provide the starting point for the second set to the regression calculator 202. The regression calculator may determine a second regression for a second set of storage usage data. The second set of storage usage data may be remaining storage usage data points that are fewer than the set size determined by the preprocessor. For example, in FIG. 1, the first set may be set 115 and the second set may be set 116. In some implementations, the second regression may be determined in the same manner as the first regression. For example, the second regression may be calculated in accordance with eq. 1.

The example system 200 may further include a forecaster 204. The forecaster 204 may use the second regression to provide a storage capacity forecast. For example, the forecaster 204 may project the second regression into the future to determine a projected data usage at a future date. As another example, the forecaster 204 may obtain a maximum capacity for the data storage system and use the second regression to determine an estimate on how long until the system reaches maximum capacity.

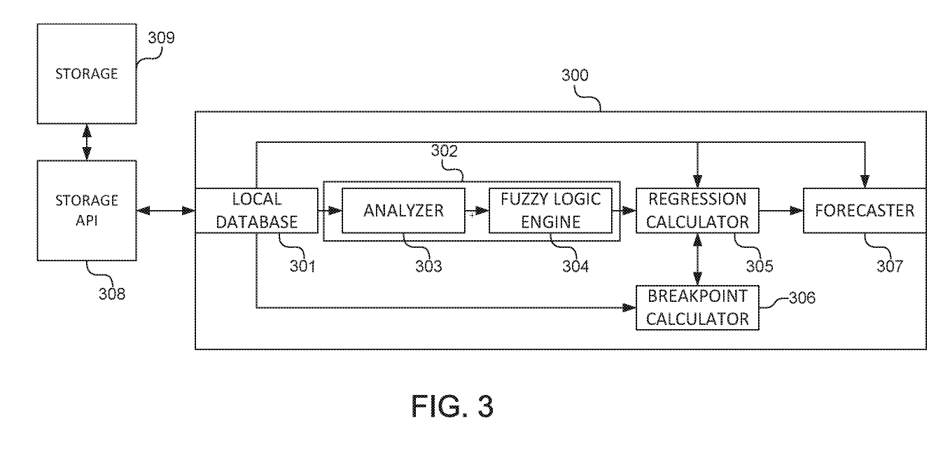

FIG. 3 illustrates an example forecasting system in a storage environment. For example, the system 300 may be an implementation of the example system 200 described with respect to FIG. 2.

In this implementation, the system 300 is connected to a storage system 309 and can communicate with the storage system 309 using an API. In some cases, the storage system 309 may be a storage system 309 connected to and providing storage for a computing system. For example, the storage system 309 may be a hard disk, solid state disk, disk array, tape drive, tape library, network attached storage (NAS), storage area network (SAN), virtual storage backup system, such as a virtual tape library or virtual disk, or a cloud-based backup system. In some implementations, the storage system 309 may include storage volumes that are used for day-to-day computer system operations, backup, or for archival purposes. For example, the storage system 309 may be a backup system that can restore files or file systems as they existed at various points in time. In some cases, the storage system 309 may store an initial full backup and subsequent incremental backups reflecting changes or edits to the protected files. Additionally, in some implementations, the storage system 309 may employ data deduplication techniques to reduce the amount of storage needed to store data.

The example system 300 may include a local database 301. In some implementations, the local database 301 may store a locally accessible copy of storage capacity data points retrieved from the storage system 309 using the API 308. The local database 301 may store pairs of time and used storage points ranging from an initial backup operation until the latest available data point. For example, the data may be of the type described with respect to FIG. 1.

The example system 300 may also include a preprocessor 302. For example, the preprocessor 302 may be an implementation of the preprocessor 201 of FIG. 2. In this example, the preprocessor may comprise an analyzer 303 and a fuzzy logic engine 304.

The analyzer 303 may obtain slope difference values and storage change ratios using storage usage data from the local database 301. These parameters may be used by the fuzzy logic engine 304 to determine the set size.

In some implementations, the analyzer 303 may obtain slope difference values by first calculating mᵢ for each data point i, where mᵢ is the slope between the ith point and the first data point, and where i>0. For example, mᵢ may be calculated as follows:

$${m}_{i} = \frac{{y}_{i} - {y}_{0}}{{x}_{i} - {x}_{0}} , \qquad ( 3 )$$

where (xᵢ, yᵢ) is the ith data point, indicating y amount of data used at time xᵢ, and (x₀, y₀) is the first data point, indicating the amount of data used at the first backup. For example, the first backup may be the data used during an initial complete backup operation. In other implementations, the slopes may be determined in other manners. For example, the analyzer 303 may calculate an approximation of the instantaneous slope at the point (xᵢ, yᵢ).

In some implementations, the analyzer 303 may use the slopes to determine the slope difference values. In some cases, for each point, the point's slope difference value may be determined as the difference between its slope and the first slope value. For example, a slope difference value sd, may be calculated as follows:

sdᵢ=mᵢ−m₁, (4)

where m is as defined in eq. (3) and sdᵢ is defined for i>2.

In some implementations, the analyzer 303 may also obtain storage change ratios using the storage usage data. For example, a storage change ratio may be a ratio of two subsequent slope change values. For example, a slope change ratio may be calculated as:

$${r}_{i} = \frac{{sd}_{i}}{{sd}_{i - 1}} , \qquad ( 5 )$$

where sd is as defined in eq. (4). For example, i may increment on a per-day basis such that the ratio rᵢ is a daily data usage change ratio.

In some implementations, the preprocessor 302 may include a fuzzy logic engine 304. The fuzzy logic engine 304 may use the parameters generated by the analyzer 303 to determine a set size for the sets upon which regression will be performed. In some implementations, the set size may be a size that is determined such that sets of the set size have linear behavior and sets larger than the set size have non-linear behavior. For example, the fuzzy logic engine 304 may use the slope difference values and storage change ratios to determine the set size. In some implementations, the fuzzy logic engine 304 may implement a fuzzy control program, such as a fuzzy control program written in Fuzzy Control Language (FCL), as standardized by the International Electro technical Commission (IEC). For example, Table 1 provides an example FCL program that generates a candidate set size, NCharacter, using a slope difference value, slopeChange, and two sequential storage change ratios, dailyChangeRatio1 and dailyChangeRatio2.

TABLE 1
Example Fuzzy Logic Program

```
FUNCTION_BLOCK NPredictor
// Define input variables
VAR_INPUT
        slopeChange : REAL;
        dailyChangeRatio1 : REAL;
        dailyChangeRatio2 : REAL;
END_VAR
// Define output variable
VAR_OUTPUT
        NCharacter : REAL;
END_VAR
// Fuzzify input variable ‘slopeChange’
FUZZIFY slopeChange
        TERM positve := (0, 0) (0.33, 1) ;
        TERM zero := (0, 1) (0.33,0) (−0.33,1) ;
        TERM negative := (−0.33, 0) (0, 1);
END_FUZZIFY
// Fuzzify input variable ‘dailyChangeRatio1’
FUZZIFY dailyChangeRatio1
        TERM above := (1, 0) (2, 1) ;
        TERM level := (1,1) (2,0) (0.5,0) ;
        TERM below := (1, 0) (0.5, 1) ;
END_FUZZIFY
// Fuzzify input variable ‘dailyChangeRatio2’
FUZZIFY dailyChangeRatio2
        TERM above := (1, 0) (2, 1) ;
        TERM level := (1,1) (2,0) (0.5,0) ;
        TERM below := (1, 0) (0.5, 1) ;
END_FUZZIFY
// Defuzzzify output variable ‘NCharacter’
DEFUZZIFY NCharacter
        TERM same := (0,1) (10,0) ;
        TERM different := (10,1) (0,1) ;
        // Use ‘Center Of Gravity’ defuzzification method
        METHOD : COG;
        // Default value is 0
        DEFAULT := 0;
END_DEFUZZIFY
RULEBLOCK No1
        // Use ‘min’ for ‘and’ (also implicit use ‘max’
        // for ‘or’ to fulfill DeMorgan's Law)
        AND : MIN;
        // Use ‘min’ activation method
        ACT : MIN;
        // Use ‘max’ accumulation method
        ACCU : MAX;
        RULE 1 : IF slopeChange IS positive AND dailyChangeRatio1
        IS above AND dailyChangeRatio2 IS above
                THEN NCharacter IS different;
        RULE 2 : IF slopeChange IS negative AND dailyChangeRatio1
        IS below AND dailyChangeRatio2 IS below
                THEN NCharacter IS different;
        RULE 3 : IF slopeChange IS zero OR dailyChangeRatio1 IS
        level OR dailyChangeRatio2 is level
                THEN NCharacter IS same;
END_RULEBLOCK
END_FUNCTION_BLOCK
```

In some implementations, the fuzzy logic engine 304 may input parameters for each successive data point into the fuzzy logic program. The fuzzy logic engine 304 may evaluate data point to determine where the data set has a slope change and consecutive change ratios having the same sign as the slope change. In some cases, the fuzzy logic engine 304 may determine the set size by calculating the result of a fuzzy logic rule. For example, the fuzzy logic rule may have a condition determining if the slope difference is positive and the two ratios are both greater than one, as illustrated in Rule 2 of Table 1. As another example, the fuzzy logic rule may have a condition determining if the slope difference is negative and the two ratios are both less than one, as illustrated in Rule 3 of Table 1. The fuzzy logic rule may also have a condition determining if the slope difference and two ratios are unchanged, as illustrated in Rule 1 of Table 1. In some implementations, the fuzzy logic engine 304 may evaluate multiple such rules simultaneously. For example, Rules 1-3 are executed in the program of Table 1.

The fuzzy logic program may output a characteristic measure of the type of change that occurs in the range from the initial data point to the evaluated data point. If the characteristic measure exceeds a threshold, the fuzzy logic engine 304 may determine the set size to be the size of the interval from the first data point to the evaluated data point. For example, in the program of Table 1, the output NCharacter is a number between 0 and 10 that indicates the strength of a candidate data point to determine the set size.

In an example implementation, the fuzzy logic engine 304 may evaluate each point of the data set until it reaches a candidate data point whose fuzzy logic program output exceeds a threshold. For example, a fuzzy logic engine 304 using the program of Table 1 may evaluate each point until a candidate data point has an NCharacter exceeding a threshold, such as 7. For example, if the fifth data point (xᵢ=5) is the first data point to have an NCharacter greater than or equal to 7, then the fuzzy logic engine may set the set size to be 5. In another example implementation, there may be a maximum set size, and the fuzzy logic engine 304 may evaluate each point of the data set until the maximum is reached. The set size may be determined as the candidate point having the greatest program output.

The example system 300 may also include a regression calculator 305, a breakpoint calculator 306, and a forecaster 307. In some implementations, the regression calculator 305, breakpoint calculator 306, and forecaster 307 may operate in a manner similar to the regression calculator 202, breakpoint calculator 203, and forecaster 204, as described with respect to FIG. 2.

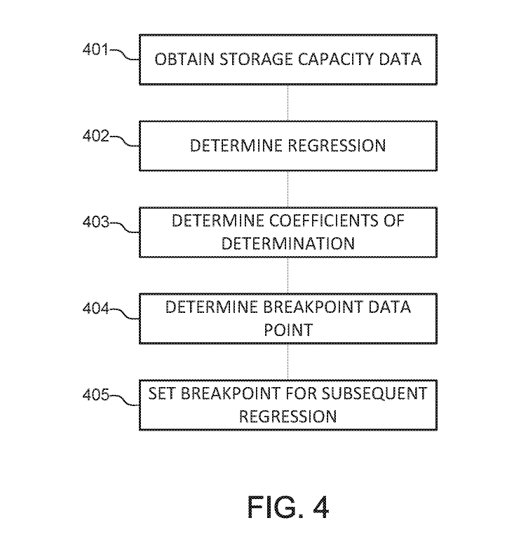

FIG. 4 illustrates an example method of setting a regression breakpoint. For example, a system such as the system 200 or 300 of FIG. 2 or 3 may perform the illustrated method.

The example method may include block 401. Block 401 may include obtaining a set of storage capacity data points. In some implementations, the set of data points may be obtained from a backup system. For example, the set of data points may be obtained from the backup system's REST API. In some cases, the set of storage capacity data points may be a time series of storage usage at backup times. As another example, the set of storage capacity data points may be a time series of storage free space at backup times. For example, the storage capacity data points may be a set of daily storage usage values.

The example method may also include block 402. Block 402 may include determining a regression from the set of storage capacity data points. In some implementations, block 402 may be performed a regression calculator such as the regression calculator 202 or 305 of FIG. 2 or 3, respectively. In some cases, the linear regression may be performed as described with respect to Eq. (1). In other cases, the linear regression may be performed in other manners, such as through a least squares approach.

The example method may also include block 403. Block 403 may include determining a set of coefficients of determination (CoD) for a subset of the set of storage capacity data points using the regression. In some implementations, block 403 may be performed by a breakpoint calculator, such as the breakpoint calculator 203 or 306 of FIG. 2 or 3. In some cases, the subset for which Cogs are determined (the CoD subset) may be the same set on which the regression is performed in block 204. In other cases, the CoD subset may be a proper subset of the regression subset. For example, the CoD subset may be every other data point in the set.

The example method may also include block 404. Block 404 may include determining a breakpoint storage capacity data point of the subset. For example, the breakpoint storage capacity data point may be a data point of the subset having a maximum CoD of the set of coefficients of determination. In some implementations, block 404 may be performed by the breakpoint calculator performing block 403.

The example method may also include block 405.In some implementations, block 405 may be performed by the breakpoint calculator performing blocks 403 and 404. Block 405 may include setting a breakpoint for a subsequent regression at the breakpoint storage capacity data point. In some cases, the breakpoint may be used as the first point in a subsequent set upon which a regression will be performed. For example, step 401 may be repeated after step 405 using the breakpoint set in block 405 as the first element of he obtained set of storage capacity data.

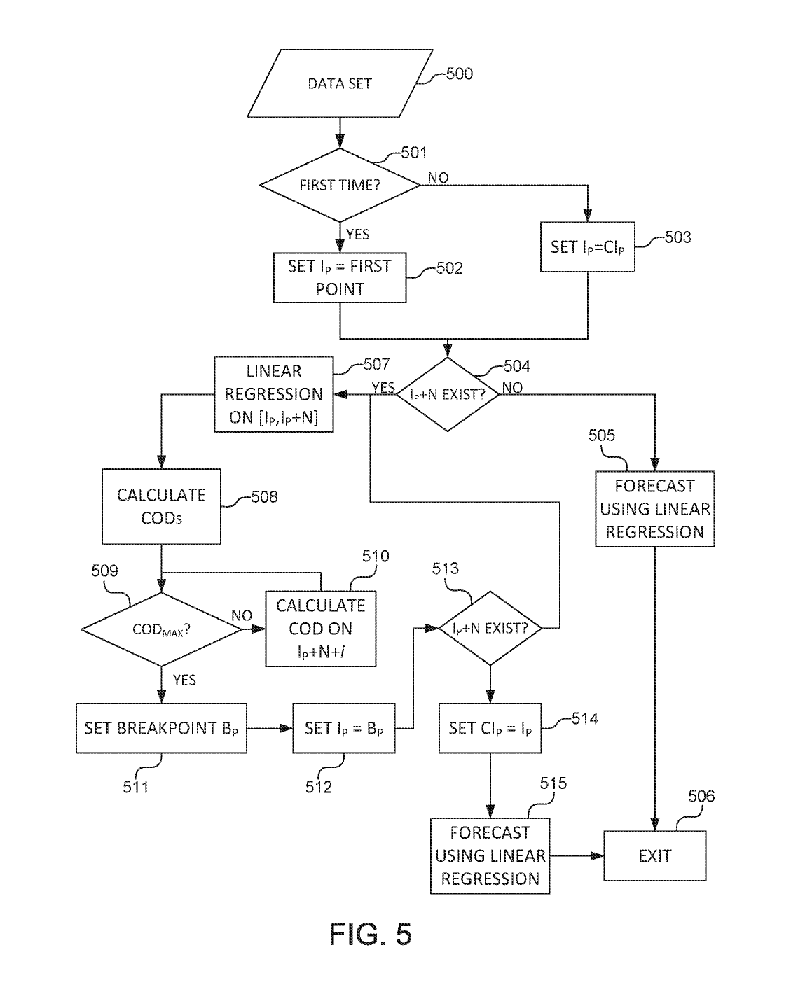

FIG. 5 illustrates an example method of operation of a storage forecaster. In some cases, the example method may implement the example method of FIG. 4. Additionally, the example method may be performed by a forecasting system such as the system 200 or 300 of FIG. 2 or 3. In some cases, the example method may be performed each time a backup operation occurs. In other cases, the example method may be performed at scheduled times or on demand.

The method may begin by obtaining a data set 500 upon which forecasting will be performed. For example, the data set 500 may be a set of all available storage capacity data points. If the method has been performed before, the data set 500 include storage capacity data points that have accumulated since the prior time the method was performed.

The example method may include block 501. In block 501, the forecasting system may determine if the current execution of the method is the first time the data set 500 has been forecast.

If the current execution is the first execution, then the method may proceed to block 502. Block 502 may include using a first data point of the data set 500 to be an initial data point For example, the first data point may be a point reflecting the data capacity used by an initial full backup of a data system. As another example, the first data point may be a point reflecting the data capacity used by an initial incremental backup of a data system.

If the method has been executed on the data set 500 previously, then the method may proceed to block 503. Block 503 may include using a cached initial data point, CI_{P}, to be the initial data point I_{P}. For example, CI_{P} may be a breakpoint storage capacity data point determined during the last previous execution of the method. In some cases, CI_{P} may be the last breakpoint determined during the last previous execution of the method.

After performing block 502 or 503, the example method may proceed to block 504. Block 504 may include determining if a data point indexed at I_{P}+ N exists in the data set 500. For example, N may be a set size determined by a preprocessor, such as the preprocessor 201 or 302 of FIG. 2 or 3, respectively. In some implementations, I_{P}+ N may exist if the current execution of the method is the first execution because the preprocessor may require at least N points to determine the value of N. Additionally, I_{P}+ N may exist if sufficient data has accumulated in the data set 500 since the immediately preceding execution of the method.

If a data point indexed at I_{P}+ N does not exist in the data set 500, then the method may proceed to block 505. Block 505 may include providing a storage capacity forecast by performing a linear regression on the data set 500. In some implementations, the linear regression may be performed on I_{P}+K, where K is the last point in the data set. For example, the linear regression may be performed in accordance with Eq. (1) on the points (x₁_{_{P}}, y₁_{_{P}}) and (x_{K}, y_{K}). The linear regression may be projected into the future to provide various forecasts. For example, a prediction of when the backup system will run out of storage space may be provided. The method may end in block 506 after performing the linear regression in block 505.

If a data point indexed at I_{P}+ N does exist in the data set 500, the method may proceed to block 507. Block 507 may include determining a regression from the data set 500. For example, the method may perform a linear regression over the interval [I_{P}, I_{P}+ N]. In some implementations, the linear regression may be performed in accordance with Eq. (1) on the points (x₁_{_{P}}, y₁_{_{P}}) and (x₁_{_{P}}_{+N}, y₁_{_{P}}_{+N}).

After performing block 507, the example method may proceed to block 508. Block 508 may include calculating CoDs on a subset of the points in the interval [I_{P}, I_{P}+ N]. For example, the CoDs may be calculated with respect to the linear regression calculated in block 507 in accordance with Eq. (2). In some implementations, the subset of the points is not a proper subset and is equal to the entire interval [I_{P}, I_{P}+ N].

After calculating the CoDs, the method may proceed to block 509. Block 509 may include determining if there is a maximal CoD, COD_{MAX}, in the set of CoDs calculated in block 508. In some implementations, a CoD is considered maximal if it is locally maximal in a subset of the interval [I_{P}, Iₚ+ N] or if it has a value of 1. For example, COD_{MAX} may be set as the first CoD, CoDᵢ in the interval [I_{P}, I_{P}+ N] to satisfy the condition CoDᵢ=1 or CoDᵢ>CoDⱼ for all j ∈ {i−2, i−1, i+1, i+2}. In other implementations, the maximal CoD satisfies the relation CoD_{MAX}>CoDⱼ for all j≠MAX in the interval [I_{P}, I_{P}+ N]. In other implementations, the maximal CoD must exceed the other CoDs by a threshold amount or percentage. For example, the maximal CoD satisfies the relation CoD_{MAX}>CoDⱼ+T where T is a threshold. In some implementations, if no maximal CoD exists in the set calculated in block 508, then the method proceeds to block 510 to determine a point having a locally maximum CoD with respect to the regression calculated in block 507.

Block 510 may include calculating a CoD for a point outside the interval [I_{P}, I_{P}+ N]. For example, a CoD may be calculated for the point at I_{P}+N+i, where i is incremented each time block 510 is performed. In some implementations, the CoD is calculated with respect to the regression line determined in block 507. For example, the regression line may be projected to the point at I_{P}+N+i, and the CoD may be calculated with respect to the projection. In some cases, i may begin at 1 and may be incremented by 1 each time block 510 is performed. After performing block 510 the method may proceed back to block 509. Subsequent performances of block 509 may determine if the CoD calculated in 510 is a locally maximal CoD, which is set to CoD_{MAX}. A locally maximal CoD may be a CoD of a point outside the interval [I_{P}, I_{P}+ N] that is greater than all CoDs calculated inside the [I_{P}, I_{P}+ N]. For example, a locally maximal CoD may be the maximal CoD in the interval [I_{P}, I_{P}+N+i]. Once a CoD_{MAX} is determined, the method may proceed to step 511. In some implementations, if the remaining data in the set 500 is evaluated and a CoD_{MAX} is not found, then the method may use the linear regression determined in step 507 to provide a forecast.

Block 511 may include setting a breakpoint, B_{P}, at the point resulting in CoD_{MAX}. The method may then proceed to block 512. In block 512, the breakpoint storage capacity data point may be set as the first element of a subsequent interval. For example, the breakpoint B_{P} may be used as the first element of a second interval by setting I_{P} to be B_{P}.

After block 512, the method may proceed to block 513. Block 513 may include determining if there are sufficient available storage capacity data points for the subsequent interval to have a length equal to the first interval. For example, block 513 may include determining if a point indexed by I_{P}+N exists in the data set 500. If there are sufficient data points, then the method may repeat from block 507. Once there are insufficient available storage capacity data points for a subsequent interval to have a length equal to the first interval, then the method may proceed to block 514.

Block 514 may include setting CI_{P} to be the current I_{P}. Accordingly, the last breakpoint determined in the final execution of block 511 will be used as the cached initial data point for subsequent performances of the method.

After caching I_{P}, the method may proceed to block 515. Block 515 may include using a linear regression determined from a subsequent interval to determine a storage capacity forecast. For example, the linear regression used in block 515 may be the regression determined in the last execution of block 507. After performing block 515, the method may end in block 506.

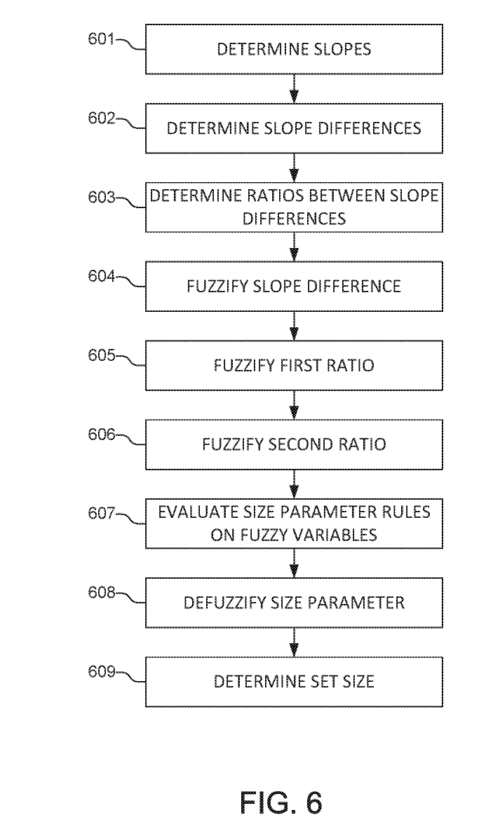

FIG. 6 illustrates an example method of determining a size of a set of storage capacity data points. For example, the method may be performed by a preprocessor, such as the preprocessor 201 or 302 of FIG. 2 or 3. In some implementations, the example method may be used to determine the set size N used in the example method of FIG. 5. For example, the method of FIG. 6 may be performed before the method of FIG. 5 is performed for the first time. As another example, the method of FIG. 6 may be performed on a scheduled or manual basis to update or revise the value of N between performances of the method of FIG. 5.

The example method may include block 601. Block 601 may include determining a first slope between a first pair of storage capacity data points and a second slope between a second pair of storage capacity data points. For example, the first slope may be the first slope is between a candidate storage capacity data point and an initial storage capacity data point. In this example, the second slope may be between a preceding storage capacity data point and the initial storage capacity data point. In some implementations, the preceding storage capacity data point is the data point immediately after the initial storage capacity data point. For example, if the initial data point is d₀, then the preceding storage capacity data point may be d₁.

The example method may also include block 602. Block 602 may include determining a slope difference between the first slope and the second slope. For example, the slope difference may be determined by subtracting the first slope from the second slope. In some implementations, the second slope is slope between the initial data point and the second (i.e., next after the initial) data point. For example, if the first slope is mₙ the second slope is m₁. In these implementations, the slope differences may be determined in accordance with Eq. (4).

The example method may also include block 603. Block 603 may include determining a first ratio between the slope difference and a preceding slope difference, and a second ratio between a succeeding slope difference and the slope difference. For example, the ratios may be determined in accordance with Eq. (5). In other implementations, block 603 may include determining only a single ratio between the slope difference and the preceding slope difference or the succeeding slope difference. However, using two ratios may avoid over fitting the set size to the data.

The example method may also include a series of fuzzy logic operational blocks 604-608. In some implementations, the fuzzy logic blocks 604-608 may be performed by a fuzzy logic engine, such as the fuzzy logic engine 304 of FIG. 3. In other implementations, the set size may be determined through other algorithms, such as binary or classical logical algorithms. In these implementations, the fuzzy logic operational blocks 604-608 may be replaced with other operational blocks.

The fuzzy logic blocks 604-608 may include fuzzification blocks 604-606. In these operational blocks, various input variables input values may be converted into degrees of membership for corresponding membership functions.

In block 604, the slope difference for a candidate data point may be fuzzified. In some implementations, the slope difference may be converted into membership in three membership functions: (a) a positive slope difference; (b) a zero, or unchanged, slope difference; and (c) a negative slope difference. For example, in the program listed in Table 1, the slope difference input, slope Change, is converted into membership in three fuzzy sets, (a) positive, (b) zero, and (c) negative.

In block 605, the first ratio for the candidate data point may be fuzzified. In some implementations, the first ratio may be converted into membership in three membership functions: (a) an increasing ratio; (b) an unchanged ratio; and (c) a decreasing ratio. The increasing ratio membership may depend on the degree in which the ratio is greater than one. The unchanged ratio membership may depend on the proximity of the ratio to one. The decreasing ratio may depend on the degree in which the ratio is less than one. For example, in the program listed in Table 1, the first ratio input, dailyChangeRatio1, is converted into membership in three fuzzy sets, (a) above, (b) level, and (c) below.

In block 606, the second ratio for the candidate data point may be fuzzified. In some implementations, the second ratio may be converted into membership functions in a manner similar to block 605. Accordingly, the second ratio may be the first ratio may be converted into membership using the three membership functions of block 605: (a) an increasing ratio; (b) an unchanged ratio; and (c) a decreasing ratio. For example, in the program listed in Table 1, the second ratio input, dailyChangeRatio2, is converted into membership in three fuzzy sets, (a) above, (b) level, and (c) below. These membership classes are defined in the same manner as the classes for dailyChangeRatio1.

The fuzzy logic blocks 604-608 may also include a step of evaluating fuzzy rules to determine a size parameter for the candidate data point. In some implementations, the fuzzy rules may include a first fuzzy logic rule and a second fuzzy logic rules. In further implementations, the fuzzy rules may include a third fuzzy logic rule. The fuzzy rules may operate on the fuzzy variables determined in blocks 603-604. In some implementations, the dependence of the rules on two ratios may prevent over fitting. Over fitting may occur if the set size is overly small, resulting in more frequent insertion of breakpoints into the data set. The two ratios may prevent a transient data point from setting the set size by requiring at least two successive backup operations to have a non-linear change with respect to the previous backup operations.

The first fuzzy logic rule may have a first condition determining if the slope difference is positive and the two ratios are both greater than one. If so, this may indicate that the candidate data point is in a location of non-linear change in the data capacity of the backup system. Accordingly, if this condition is met, the candidate data point may be a potential location to set the set size. Thus, the size parameter may belong to a fuzzy set indicating that the candidate data point may determine the set size. For example, the program listed in Table 1 has a rule, RULE 1, having a condition determining if slope Change is positive or dailyChangeRatio1 is above and dailyChangeRatio2 is above. If so, then the size parameter NCharacter is assigned membership in the fuzzy set different.

The second fuzzy logic rule may have second condition determining if the slope difference is negative and the two ratios are both less than one. If so, the size parameter may belong to the fuzzy set indicating that the candidate data point may determine the set size. For example, RULE 2 of Table 1 has a condition determining if slope Change is positive or dailyChangeRatio1 is above and dailyChangeRatio2 is above. If so, then NCharacter is assigned membership indifferent.

The third logic rule may have a third condition determining if the slope difference is zero or at least one of the two ratios is unchanged. If this condition is met, the candidate data point may be at a location of linear change in the data capacity of the backup system. If so, the size parameter may belong to a fuzzy set indicating that the candidate data point will not determine the set size. For example, RULE 3 of Table 1 has a condition determining if slopeChangeiszeroordailyChangeRatio1islevelordailyChangeRatio2islevel. If so, then NCharacter is assigned membership in the fuzzy set same.

The fuzzy logic operations 603-608 may include block 608. In block 608, the size parameter may be defuzzified. The defuzzification may convert the fuzzy size parameter into a numerical value. For example, the defuzzification may convert the size parameter into a numerical value on an interval. For example, in the program of Table 1, NCharacter is defuzzified to yield a value between zero and ten. A candidate data point producing an NCharacter with a higher degree of membership in different produces a numerical value closer to ten. Conversely, a candidate data point producing an NCharacter with a higher degree of membership in same produces a numerical value closer to zero.

The method may also include block 609. In block 609, the output of the fuzzy operations 603-608 may be used to determine if the candidate data point should set the set size. For example, block 609 may using the candidate data point to set the set size if the output exceeds a threshold. For example, the size may be a length of an interval from the initial storage capacity data point and the candidate data point. For example, the set size, N, in FIG. 5 may be set as the index of the candidate data point if the output of the operations 603-608 is greater than seven. If the candidate data point has an output less than the threshold, the method may be repeated with the next point in the set as the new candidate data point.

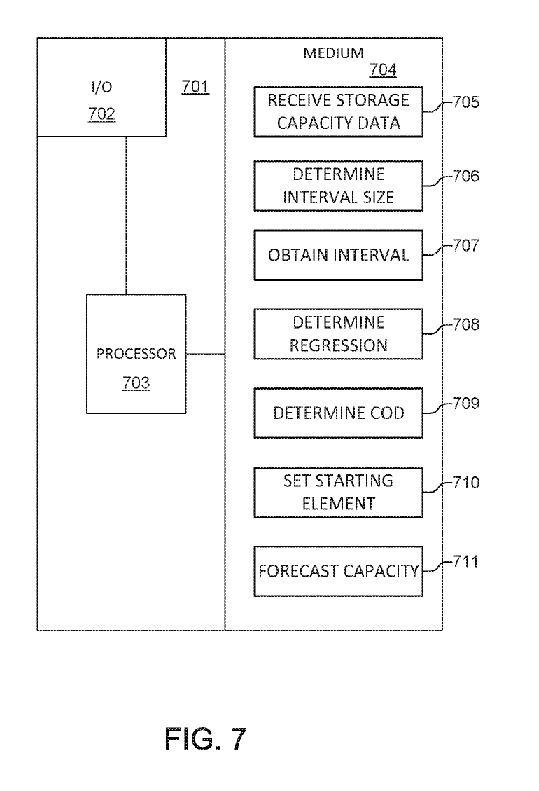

FIG. 7 illustrates a computer 701 having a non-transitory computer readable medium 704 storing instruction executable by a processor 703 to perform a regression on a series of a storage capacity data points. In some implementations, the illustrated computer 701 may implement a forecasting system, such as the forecasting system 200 or 300 of FIG. 2 or 3. Additionally, the illustrated computer 701 may perform a forecasting method such as the methods illustrated in FIGS. 4-6.

The computer 701 may include an input/output subsystem (I/O) 702. For example, I/O 702 may include a network interface, such as wired or wireless network interface. I/O 702 may also include peripheral interfaces, such as interfaces for monitors, keyboards, mice, or other devices.

The computer 702 may also include a processor 703. In various implementations, the processor may include one or more physical processors or processor cores. In further implementations, the processor 703 may include a central processing unit (CPU), graphical processing unit (GPU), other specialized processor, or a combination thereof.

The computer 702 may also include a non-transitory computer readable medium 704. In some implementations, the non-transitory computer readable medium 704 may include volatile or non-volatile memory, such as random access memory (RAM), flash memory, read-only memory (ROM), storage, or a combination thereof.

In some implementations, the medium 704 may store instructions 705. The instructions 705 may be executable by the processor to receive a series of storage capacity data points. In some cases, the instructions 705 may be executable by the processor to use the I/O to receive the series. For example, the processor may use a backup system's REST API to receive time-indexed storage capacity data through a network connection.

In some implementations, the medium 704 may store instructions 706. The instructions 706 may be executable by the processor to determine an interval size. In some implementations, the instructions 706 may be executable by the processor to perform the method described with respect to FIG. 6. For example, the instructions 706 may cause the processor 703 to determine a series of slope differences. As discussed above, each slope difference k of the slope difference series may be between a first slope and a second slope. For example, the slope differences may be determined in accordance with Eq. (3). In this case, the first slope may be between a kth storage capacity data point of the series and an initial storage capacity data point of the series. The second slope may be between the second data point of series (i.e., k=2) and the initial capacity data point of the series. A candidate data point, such as the nth data point may determine the interval size. For example, the instructions 706 may use the nth slope difference of the series of slope differences to determine the interval size.

In some implementations, the instructions 706 may also cause the processor 703 to determine a series of storage change ratios. For example, the storage change ratios may be determined in accordance with Eq. (4). In some cases, each storage change ratio j of the series of storage change ratios may be between a jth slope difference and a j−1th slope difference. The instructions 706 may further cause the processor to use the nth storage change ratio and the n+1th storage change ratio to determine the size of the first interval. In other cases, the instructions may cause the processor to use the nth storage change ratio and the n−1th storage change ratio to determine the size of the first interval.

In further implementations, the instructions 706 may cause the processor 703 to execute fuzzy logic rules to determine the interval size as n. The instructions 706 may cause the processor 703 to determine the size of the first interval as n if an output of a fuzzy logic rule operating on the nth slope difference, the nth storage change ratio, and the n+1th storage change ratio exceeds a threshold. For example, the instructions 706 may include a fuzzy logic control program, such as the program listed in Table 1.

The medium 704 may further store instructions 707. The instructions 707 may be executable by the processor 703 to obtain a first interval of storage capacity data points from the series. In some implementations, the first interval may be an interval having the interval size determined by the processor 703 executing the instructions 706.

The medium 704 may further also store instructions 708. The instructions 708 may be executable by the processor 703 to determine a regression from the first interval. For example, the regression may be a linear regression determined in accordance with Eq. (1). For example, the instructions 707-708 may cause the processor to perform the steps 504 and 507 of the method described with respect to FIG. 5.

The medium 704 may further include instructions 709. The instructions 708 may be executable by the processor 703 to determine CoDs. For example, the instructions 708 may cause the processor 703 to determine a CoD with respect to the regression for each storage capacity data point of the first interval. In some cases, the CoDs may be determined in accordance with Eq. (2).

The medium 704 may further include instructions 710. The instructions 710 may be executable by the processor 703 to set a starting element for a second interval of storage capacity data points. For example, the starting element may be a breakpoint determined from the regression of the first interval. In some cases, if a maximal CoD does not exist in the first interval, the instructions 710 may cause the processor 703 to set the starting element at the maximal capacity data point having the maximal CoD. If a maximal CoD does not exist in the first interval, the instructions 710 may cause the processor 703 to set the starting element at a locally maximal storage capacity data point outside the interval and having a locally maximal CoD with respect to the regression.

The medium 704 may further include instructions 711. The instructions 711 may be executable by the processor 703 to obtain a storage capacity forecast. For example, the instructions 711 may cause the processor 703 to execute the instructions 707 to obtain the second interval of storage capacity data points from the series of storage capacity data points. The instructions 711 may be further executable by the processor 703 to determine if there are sufficient storage capacity data points in the series to allow the second interval to have an equal length to the first interval. If there are not, then the instructions 711 may cause the processor to execute the instructions 708 to determine a second regression from the second interval. The instructions 711 may further cause the processor 703 to determine the storage capacity forecast using the second regression.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A system, comprising;
A preprocessor to determine a set size from storage usage data;
a regression calculator to determine a first regression for a first set of storage usage data and to determine a second regression for a second set of storage usage data, the first set having the set size;
a breakpoint calculator to set a starting point for a second set at a point having a maximal displacement with respect to the first regression; and
a forecaster to use the second regression to provide a storage capacity forecast.

2. The system of claim 1, wherein the point having the maximal displacement has a locally maximal coefficient of determination with respect to the first regression.

3. The system of claim 1, wherein the preprocessor comprises
an analyzer to obtain slope difference values and storage change ratios using storage usage data; and
a fuzzy logic engine to use the slope difference values and storage change ratios to determine the set size.

4. A method, comprising:
obtaining a set of storage capacity data points;
determining a regression from the set of storage capacity data points;
determining a set of coefficients of determination for a subset of the set of storage capacity data points using the regression;
determining a breakpoint storage capacity data point of the subset having a maximal coefficient of determination of the set of coefficients of determination; and
setting a breakpoint for a subsequent regression at the breakpoint storage capacity data point.

5. The method of claim 4, further comprising:
if there is no storage capacity data point of the subset having a maximum coefficient of determination, determining a second storage capacity data point outside of the set of storage capacity data points having a locally maximum coefficient of determination with respect to the regression.

6. The method of claim 4, wherein the set of storage capacity data points is a first interval of storage capacity data points and the subset is the entire first interval, the method further comprising:
obtaining a second interval of storage capacity data points, the second interval having the breakpoint storage capacity data point as a first element; and
if there are insufficient available storage capacity data points for the second interval to have a length equal to the first interval,
determining a second regression from the second interval, and
determining a storage capacity forecast using the second regression.

7. The method of claim 4, further comprising:
determining a size of the set of storage capacity data points using a slope difference between a first slope between a first pair of storage capacity data points and a second slope between a second pair of storage capacity data points.

8. The method of claim 7, wherein:
the first slope is between a candidate storage capacity data point and an initial storage capacity data point; and
the second slope is between a preceding storage capacity data point and the initial storage capacity data point.

9. The method of claim 8, further comprising:
determining the size using a first ratio between the slope difference and a preceding slope difference, and using a second ratio between a succeeding slope difference and the slope difference.

10. The method of claim 9, wherein:
the candidate data point satisfies a first fuzzy logic rule or a second fuzzy logic rule, the first fuzzy logic rule having a first condition determining if the slope difference is positive and the two ratios are both greater than one, and the second fuzzy logic rule having a second condition determining if the slope difference is negative and the two ratios are both less than one; and
the size is a length of an interval from the initial storage capacity data point and the candidate data point.

11. The method of claim 10, wherein the candidate data point does not satisfy a third fuzzy logic rule having a third condition determining if the slope difference is zero or at least one of the two ratios is unchanged.

12. A non-transitory computer readable medium storing instructions executable by a processor to:
receive a series of storage capacity data points;
obtain a first interval of storage capacity data points from the series;
determine a regression from the first interval;
determine a coefficient of determination with respect to the regression for each storage capacity data point of the first interval;
if a maximal coefficient of determination exists in the first interval, set a starting element for a second interval of storage capacity data points at a maximal capacity data point having the maximal coefficient of determination; and
if a maximum coefficient of determination does not exist in the first interval, set the starting element at a locally maximal storage capacity data point outside the interval having a locally maximal coefficient of determination with respect to the regression.

13. The non-transitory computer readable medium of claim 12 storing further instructions executable by the processor to:
obtain the second interval of storage capacity data points from the series of storage capacity data points; and
if there are insufficient storage capacity data points in the series to allow the second interval to have an equal length to the first interval,
determine a second regression from the second interval, and
determine a storage capacity forecast using the second regression.

14. The non-transitory computer readable medium of claim 12 storing further instructions to:
determine a series of slope differences, each slope difference k of the slope difference series being between a first slope and a second slope, the first slope being between a kth storage capacity data point of the series and an initial capacity data point of the series, and the second slope being between a second storage capacity data point of the series and the initial capacity data point of the series; and
determine a size of the first interval using an nth slope difference of the series of slope differences.

15. The non-transitory computer readable medium of claim 14 storing further instructions to:
determine a series of storage change ratios, each storage change ratio j of the series of storage change ratios being between a jth slope difference and a j−1th slope difference; and
use an nth storage change ratio and an n+1th storage change ratio to determine the size of the first interval.
